(19) United States
(12) Patent Application Publication
(10) Pub. No.: US 2012/0046923 A1
(43) Pub. Date: Feb. 23, 2012

(54) Circuit performance estimation device and circuit performance estimation method

(75) Inventor: Yu Liu, Kawasaki (JP)

(73) Assignee: FUJITSU LIMITED, Kawasaki (JP)

(21) Appl. No.: 13/067,267

(22) Filed: May 19, 2011

(30) Foreign Application Priority Data
Aug. 17, 2010 (JP) 2010-182297

(51) Int. Cl. G06F 17/50

(52) U.S. Cl. 703/2

(57) ABSTRACT

A circuit performance estimation method for estimating circuit performances includes acquiring terms from a recording unit recording the terms included in model formulas indicating relationships between circuit performances and parameters; generating new model formulas by combining the terms acquired at the acquiring; performing simulation on the new model formulas generated at the generating; and selecting a model formula that satisfies a precision request from among the new model formulas, based on simulation results obtained at the performing of the simulation.

### CROSS-REFERENCE TO RELATED APPLICATION

This patent application is based upon and claims the benefit of priority of the prior Japanese Patent Application No. 2010-182297 filed on Aug. 17, 2010, the entire contents of which are incorporated herein by reference.

### FIELD

The embodiments discussed herein are related to a circuit performance estimation device and a circuit performance estimation method, and a computer-readable, non-transitory medium.

### BACKGROUND

For example, a chip that is a packaged semiconductor integrated circuit is designed and manufactured as illustrated in FIG. 1. FIG. 1 is an example of a flowchart illustrating processes for designing and manufacturing a chip. As illustrated in FIG. 1, a process S10 of designing a chip includes a step of designing the circuit topology (step S11), a step of determining topology design parameters (step S12), and a laying out and masking step (step S13).

A process S20 for manufacturing the chip includes a step of a pre-process (step S21), and a step of a post-process and a test (step S22). For example, the pre-process (step S21) includes exposing, etching, oxidation diffusion, CVD (chemical vapor deposition), ion implanting, polishing, etc. The post-process includes chip dicing, mounting, bonding, molding, separating, etc.

In the pre-process, a TEG (test element group) 1 is used to find problems in manufacturing the chip. The TEG 1 is an evaluation element appropriate for determining the cause of a problem arising in the pre-process (step S21). Process parameters (Vth, U0, tox, etc.) 2 are collected by using the TEG 1 in the pre-process (step S21). In the pre-process (step S21), the process parameters 2 may vary due to variations in the size, the pressure, and the temperature, which may affect the yield ratio of the chip.

There is conventionally known a method of controlling the yield ratio to optimize the semiconductor manufacturing process. This method involves obtaining the standard deviation from a product prediction model and the probability of attaining a product standard value, as functions of process condition values (see, for example, patent document 1).
Patent document 1: Japanese Laid-Open Patent Publication No. S58-145148

Variations in the process parameters 2 increase as the pre-process (step S21) included in the process S20 for manufacturing the chip becomes refined. That is to say, the summation of variations in the process parameters 2 increases. Thus, in order to improve the yield ratio of chips, the yield ratio of chips needs to be considered at the process S10 of designing the chip. In order to consider the yield ratio of chips at the process S10 of designing the chip, a technology for estimating the yield ratio of chips is needed.

Furthermore, as the pre-process (step S21) included in the process S20 for manufacturing the chip becomes refined, random variations become dominant in the process parameters 2. Therefore, in the process S10 of designing the chip, variations within a chip (intra-die variations) need to be taken into consideration. Consequently, a large number of process parameters 2 that affect the yield ratio of chips are used.

FIG. 2 is for describing examples of inter-die variations and intra-die variations. Inter-die variations are variations in the process parameters 2 between chips (dies) 11 and 12, for example. In this case, it is assumed that there are no variations in the process parameters within each of the chips 11 and 12. Meanwhile, intra-die variations are variations in the process parameters 2 within a chip 13, for example. In this case, it is assumed that there are variations in the process parameters 2 inside the chip 13.

As a technology for estimating the yield ratio of chips in the process S10 of designing the chip, there is a Monte-Carlo simulation method such as SPICE (Simulation Program with Integrated Circuit Emphasis). SPICE is an example of a circuit simulator for simulating analog operations of electronic circuits.

In the process S10 of designing the chip, when the yield ratio of the chip is estimated, the Monte-Carlo simulation method needs to be performed numerous times until the distribution of the chip performance is determined. The circuit simulator of SPICE involves high load processing. Therefore, it takes a long time to estimate the yield ratio of chips in a Monte-Carlo simulation method by a circuit simulator.

When the processing load of the circuit simulator such as SPICE is reduced, the margin of error becomes high in the estimation of the yield ratio of chips in the process S10 of designing the chip. The technology described in patent document 1 is for increasing the yield ratio of products by improving the process of manufacturing semiconductors; however, the technology described in patent document 1 is not for increasing the yield ratio of products by improving the process of designing semiconductors.

### SUMMARY

According to an aspect of the invention, a computer-readable, non-transitory medium stores a program that causes a computer for estimating circuit performances to execute a procedure, the procedure including acquiring terms from a recording unit recording the terms included in model formulas indicating relationships between circuit performances and parameters; generating new model formulas by combining the terms acquired at the acquiring; performing simulation on the new model formulas generated at the generating; and selecting a model formula that satisfies a precision request from among the new model formulas, based on simulation results obtained at the performing of the simulation.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is an example of a flowchart illustrating processes for designing and manufacturing a chip;

FIG. 2 is for describing examples of inter-die variations and intra-die variations;

FIG. 3 is for describing an example of a process for obtaining the variation distribution of the chip performance by the Monte-Carlo simulation method by SPICE;

FIG. 4 is for describing an example of a process for obtaining the variation distribution of the chip performance by the Monte-Carlo simulation method by model formulas;

FIG. 5 is an example of a table indicating errors, coefficients, and modeling times in a linear model and in a second order polynomial model;

FIG. 6 is a graph indicating values of coefficients of terms included in the second order polynomial model;

FIG. 7 illustrates a hardware configuration of an example of a computer for executing a circuit performance estimation program;

FIG. 8 is a block diagram of an example of a circuit performance estimation device according to the present embodiment;

FIG. 9 is a block diagram of an example of details of a model formula generating unit according to the present embodiment;

FIG. 10 is a flowchart of procedures of a modeling process;

FIG. 11 is a flowchart indicating details of step S56 in FIG. 10;

FIG. 12 illustrates a configuration of an example of a term library;

FIG. 13 illustrates the association between model formulas and errors (precision) of the model formulas;

FIG. 14 illustrates an example of genetic algorithm information; and

FIG. 15 indicates effects of the present embodiment by comparing the present embodiment with conventional methods.

### DESCRIPTION OF EMBODIMENTS

Preferred embodiments of the present invention will be explained with reference to accompanying drawings. A circuit performance estimation device and a circuit performance estimation method according to the embodiments are merely examples, and may be referred to as an apparatus and a method having different names.

In the following embodiments, the field ratio of chips is estimated with a Monte-Carlo simulation method by model formulas, instead of a Monte-Carlo simulation method by SPICE. In the model formula, the relationship between the circuit performance of the chip and the process parameters 2 is modeled. The calculation load of model formulas is much lower than that of SPICE.

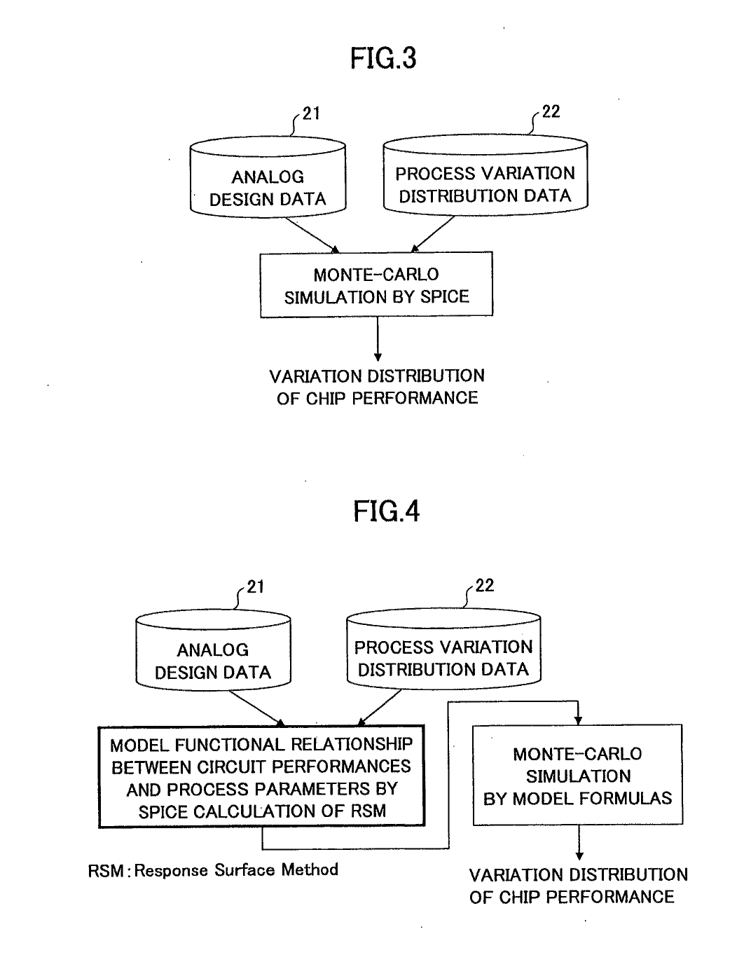

Therefore, the processing time of the Monte-Carlo simulation method by model formulas is shorter than that of the Monte-Carlo simulation method by SPICE. FIG. 3 is for describing an example of a process for obtaining the variation distribution of the chip performance by the Monte-Carlo simulation method by SPICE. FIG. 4 is for describing an example of a process for obtaining the variation distribution of the chip performance by the Monte-Carlo simulation method by model formulas.

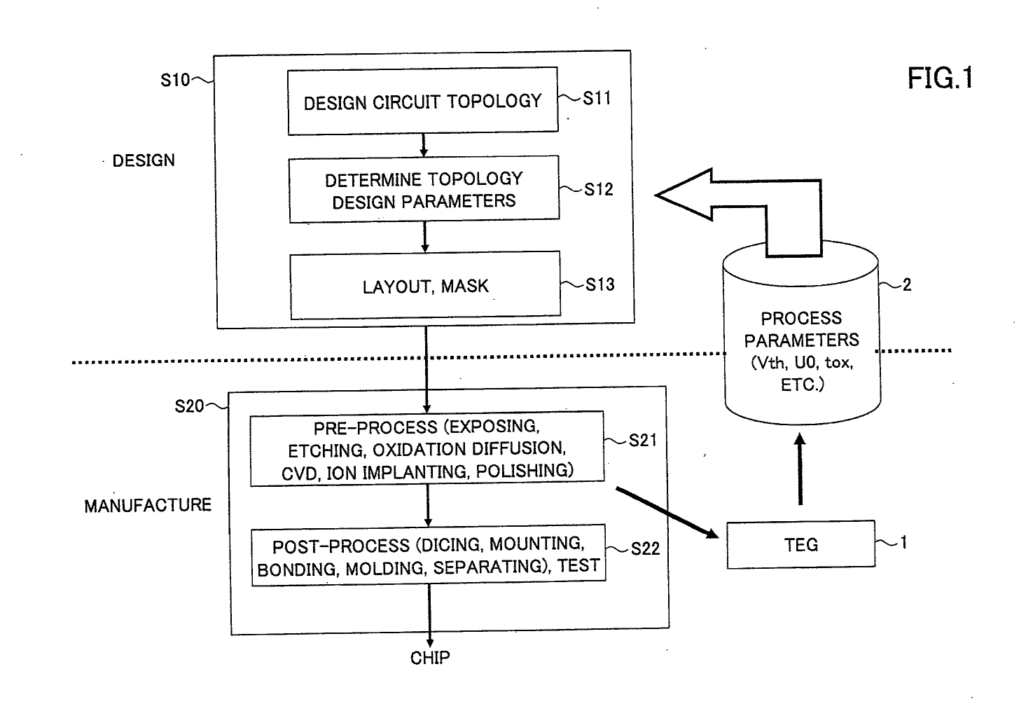

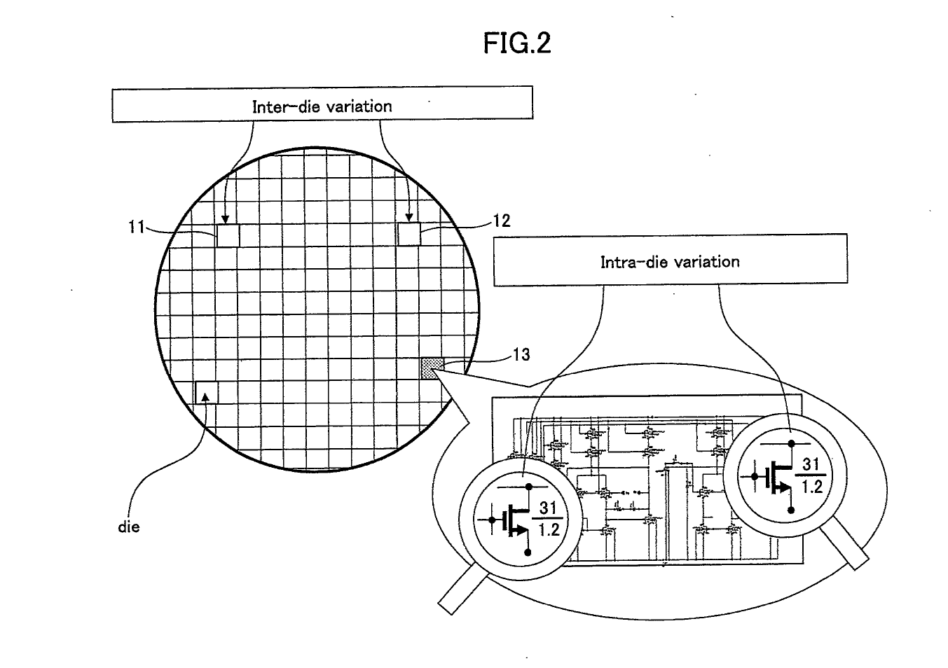

FIG. 3 indicates that the Monte-Carlo simulation method by SPICE is performed with the use of analog design data 21 and process variation distribution data 22. The process variation distribution data 22 is, for example, the process parameters 2 of FIG. 1. The processing load of the Monte-Carlo simulation method by SPICE is significantly high, and therefore the processing time for obtaining the variation distribution of the chip performance is considerably long.

FIG. 4 indicates that the Monte-Carlo simulation method by model formulas is performed after the functional relationship between the circuit performance and the process parameters is modeled by a SPICE calculation of RSM (Response Surface Method) with the use of the analog design data 21 and the process variation distribution data 22. The processing load of the Monte-Carlo simulation method by model formulas is significantly lower than that of the Monte-Carlo simulation method by SPICE, and therefore the processing time for obtaining the variation distribution of the chip performance is shorter than that of the Monte-Carlo simulation method by SPICE.

A description is given of modeling techniques. Modeling techniques include linear models according to linear approximation and polynomial models according to high-degree polynomial approximation. The linear model involves modeling the relationship between the circuit performance of the chip and the process parameters 2 by the following formula (1).

P=a₀+a₁p₁+a₂p₂+ . . . +aₙpₙ (1)

P represents the circuit performance of the chip, and p₁ through pₙ represents the process parameters 2. For example, p₁ through pₙ correspond to Vth_m0, U0_m0, Tox_m0, Vth_m1, U0_m1, Tox_m1. In the linear model, in order to obtain coefficients {a₀, a₁, . . . , aₙ} from a simulation data set {P, p₁, p₂, . . . , pₙ}, at least n+1 simulation data sets are needed.

In the polynomial model, the relationship between the circuit performance of the chip and the process parameters 2 is modeled by the following formula (2), for example. Formula (2) represents a polynomial model of the m-th order. For example, a polynomial model of a second order including two process parameters 2 is expressed by the following formula (3).

$$\begin{matrix}P = {\sum }_{i} {a}_{i} \underline{{p}_{0}^{di0} … {p}_{n}^{din}} , 0 \leq {d}_{in} \leq m & ( 2 ) \\ P = {a}_{0} + {a}_{1} \underline{{p}_{1}} + {a}_{2} \underline{{p}_{2}} + {a}_{3} \underline{{p}_{1} {p}_{2}} + {a}_{4} \underline{{p}_{1}^{2}} + {a}_{5} \underline{{p}_{2}^{2}} & ( 3 )\end{matrix}$$

In formula (2) and formula (3), p₁ through pₙ correspond to terms. In an m-th order polynomial model, greater than or equal to Σ(n+m−1)Cm simulation data sets are needed. Incidentally, n parameters express the number of process parameters 2. When there are n parameters in the m-th order polynomial model (in the case of an n parameter m-th order polynomial model), the number of the simulation data sets used need to be proportional to the number of terms.

The linear model and the polynomial model described above have the following problems. For example, in accordance to an increase in the summation of variations in the process parameters 2, errors in the linear model increase. For example, formula (4) expresses nonlinear properties of a transistor. Because the transistor has nonlinear properties, the errors in the linear model increase.

### Nonlinear Properties of Transistor

$$EXAMPLE \text{:} {I}_{ds} = \frac{{μ}_{0} {C}_{ox} W}{2 L} {( {V}_{gs} - {V}_{th} )}^{2} \qquad ( 4 )$$

Furthermore, as random variations are dominant in the process parameters 2, the number of terms, which are polynomial parameters, exponentially increases in the polynomial model. Therefore, in the polynomial model, in order to perform fitting, the processing time of SPICE for calculating the simulation data set exponentially increases.

For example, when the number of process parameters 2 is 200 (200 variables), calculations by SPICE need to be performed 201 times or more in the linear model. In the second order polynomial model, calculations by SPICE need to be performed 20,301 times or more. In a third order polynomial model, calculations by SPICE need to be performed 1,373,701 times or more.

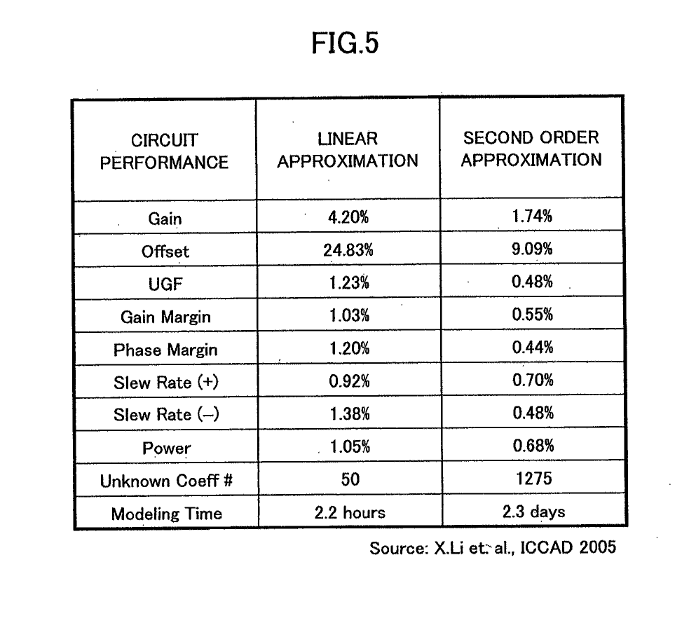

FIG. 5 is an example of a table indicating errors, coefficients, and modeling times in the linear model and in the second order polynomial model. FIG. 5 illustrates an example where the chip is an operational amplifier. The linear model includes circuit performances having large errors.

For example, a circuit performance “Offset” has a large error of 24.83%. Meanwhile, in the second order polynomial model, the modeling time is long, i.e., 2.3 days.

The modeling time is proportionate to the number of coefficients. For example, the second order polynomial model has 25.5 times as many coefficients as those of the linear model. Furthermore, the modeling time of the second order polynomial model is 25.1 times as long as that of the linear model. When the number of coefficients of the second order polynomial model increases, the modeling time increases proportionately. That is to say, the fitting time needed for fitting increases proportionately to an increase in the number of coefficients of the second order polynomial model.

Thus, in the present embodiment, a new model time is created, with which the precision and the modeling time are balanced. Accordingly, the precision in estimating circuit performances of the chip and the processing time are balanced.

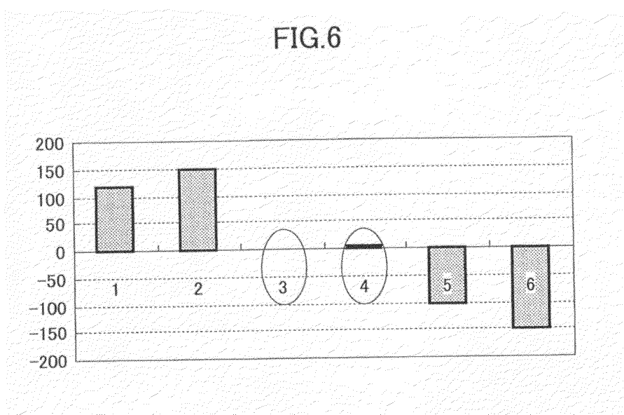

In the present embodiment, considering that the fitting time is proportionate to the number of terms, an attempt is made to reduce the fitting time by reducing the number of terms in the model formula. For example, as illustrated in FIG. 6, when the coefficients of the third and fourth terms included in the second order polynomial model of formula (5) are clearly smaller than the coefficients of the other terms, the third and fourth terms are deleted, so that the formula (6) is created. FIG. 6 is a graph indicating the values of coefficients of terms included in the second order polynomial model.

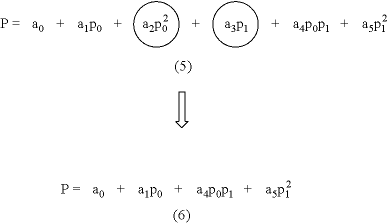

Formula (6) is a model formula with which the fitting time is reduced without hardly degrading the precision. According to the model formula of formula (6), the number of simulation data sets needed for the Monte-Carlo simulation method is reduced.

However, if a coefficient that is clearly smaller than coefficients of other terms is deleted after coefficients of terms of the model formula are obtained, it is not possible to reduce the number of simulation data sets that are needed for obtaining coefficients of terms of the model formula. Accordingly, in the present embodiment, a model formula having few errors is selected from model formulas (7) that are created by combining terms of the formula (5).

$$\begin{matrix}1 ) ) {a}_{0} + {a}_{1} {p}_{0} + {a}_{2} {p}_{0}^{2} + {a}_{3} {p}_{1} \\ 2 ) ) {a}_{0} + {a}_{1} {p}_{0} + {a}_{2} {p}_{0}^{2} + {a}_{4} {p}_{0} {p}_{1} ,\end{matrix} \} \qquad ( 7 )$$

The process of selecting a model formula in which the precision and the processing (fitting) time are balanced from among the formulas (7) created by combining terms of the model formula (5), is described below.

### Hardware Configuration

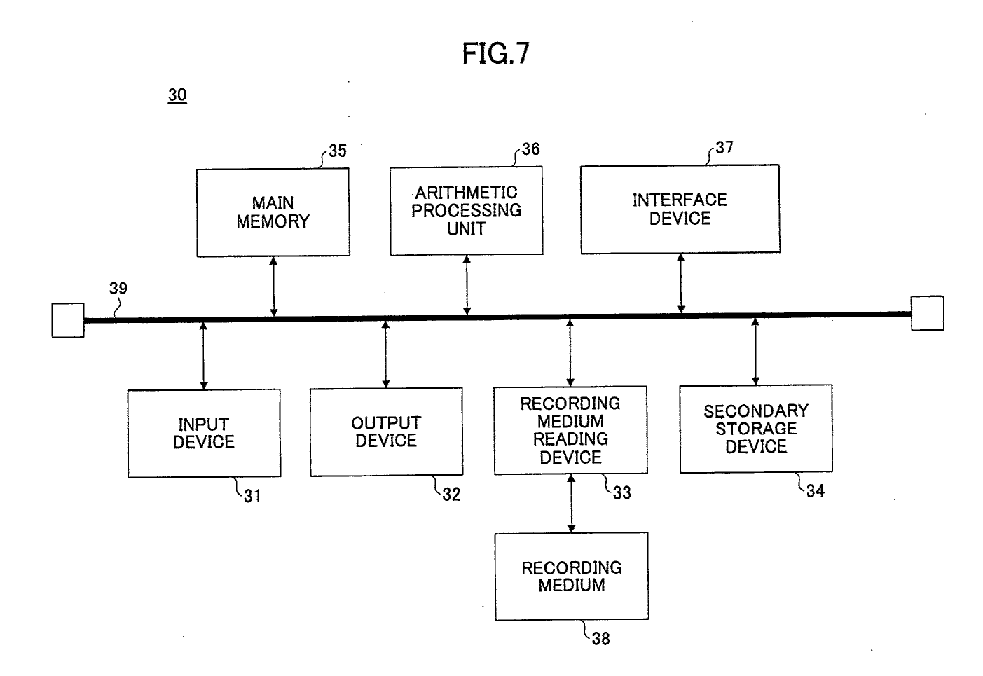

FIG. 7 illustrates a hardware configuration of an example of a computer for executing a circuit performance estimation program. A computer 30 illustrated in FIG. 7 includes an input device 31, an output device 32, a recording medium reading device 33, a secondary storage device 34, a main memory 35, an arithmetic processing unit 36, and an interface device 37, which are interconnected by a bus 39.

The input device 31 may be a keyboard and a mouse. The input device 31 is used for inputting various signals. The output device 32 may be a display device. The output device 32 is used for displaying various windows and data. The interface device 37 may be a modem or a LAN card. The interface device 37 is used for connecting to the network.

The circuit performance estimation program according to the present embodiment is at least part of various programs for controlling the computer 30 of FIG. 7. The circuit performance estimation program may be provided by being distributed in a recording medium 38 or by being downloaded from a network. Various types of recording media may be used as the recording medium 38 recording the circuit performance estimation program, including a recording medium for optically, electrically, or magnetically recording information such as a CD-ROM, a flexible disk, a magneto optical disk, etc., or a semiconductor memory for electrically recording information such as a ROM or a flash memory.

When the recording medium 38 recording the circuit performance estimation program is set in the recording medium reading device 33, the circuit performance estimation program is installed in the secondary storage device 34 from the recording medium 38 via the recording medium reading device 33. The circuit performance estimation program downloaded from the network is installed in the secondary storage device 34 via the interface device 37. The secondary storage device 34 also stores relevant files and data together with the installed circuit performance estimation program.

When the circuit performance estimation program is activated, the main memory 35 reads the circuit performance estimation program from the secondary storage device 34 and stores the circuit performance estimation program. The arithmetic processing unit 36 implements various processes described below, according to the circuit performance estimation program stored in the main memory 35. The computer 30 for executing the circuit performance estimation program is one example of a circuit performance estimation device.

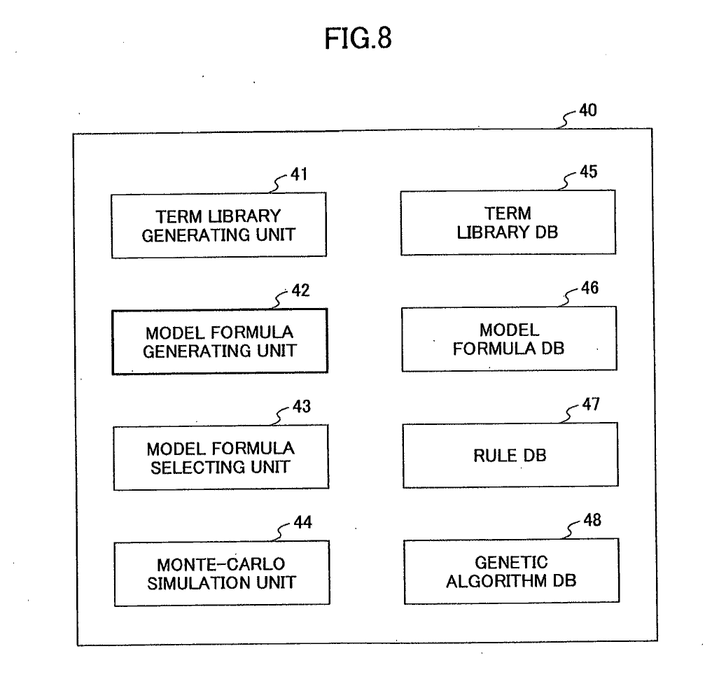

The computer 30 for executing the circuit performance estimation program implements various processes as indicated in FIG. 8. FIG. 8 is a block diagram of an example of the circuit performance estimation device.

A circuit performance estimation device 40 includes a term library generating unit 41, a model formula generating unit 42, a model formula selecting unit 43, a Monte-Carlo simulation unit 44, a term library DB 45, a model formula DB 46, a rule DB 47, and a genetic algorithm DB 48.

The term library generating unit 41 generates a term library including terms of the model formula. The model formula generating unit 42 generates a model formula by combining one or more terms included in the term library. The model formula selecting unit 43 selects a model formula generated by the model formula generating unit 42 if the corresponding model formula satisfies a precision request. The Monte-Carlo simulation unit 44 performs a Monte-Carlo simulation on the model formula selected by the model formula selecting unit 43.

The term library DB 45 records a term library. The model formula DB 46 records a model formula in association with the error (precision) of the corresponding model formula. The rule DB 47 records rules of model formulas generated by the model formula generating unit 42. The genetic algorithm DB 48 records genetic algorithm information used in a genetic algorithm described below.

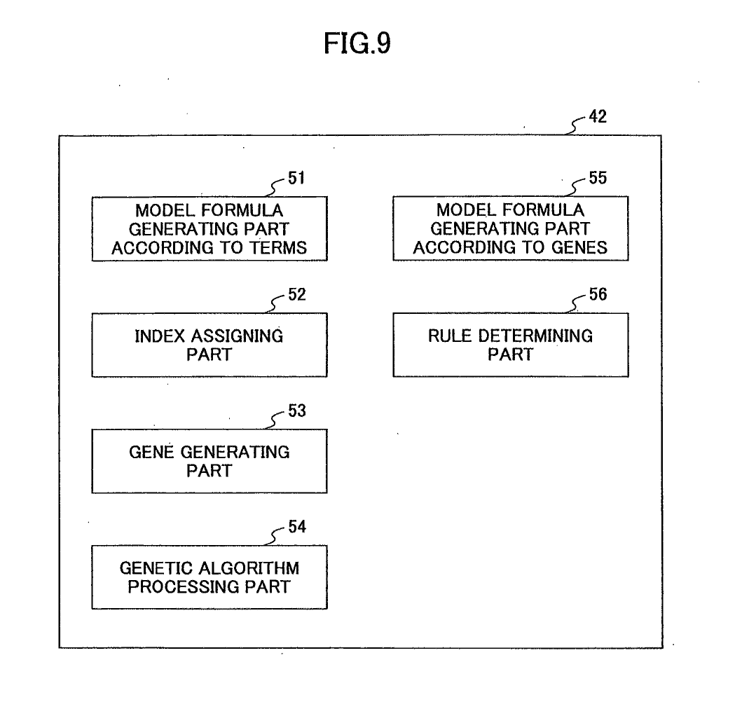

FIG. 9 is a block diagram of an example of details of the model formula generating unit 42 according to the present embodiment. The model formula generating unit 42 includes a model formula generating part 51 according to terms, an index assigning part 52, a gene generating part 53, a genetic algorithm processing part 54, a model formula generating part 55 according to genes, and a rule determining part 56.

The model formula generating part 51 according to terms generates a model formula by combining one or more terms included in the term library. The index assigning part 52 assigns an index to each term in the term library recorded in the term library DB 45. The gene generating part 53 generates a gene of an individual by combining one or more terms included in the term library. The genetic algorithm processing part 54 searches for a new individual according to a genetic algorithm.

The model formula generating part 55 according to genes generates a model formula from a gene of a new individual found by the genetic algorithm processing part 54. The rule determining part 56 determines whether the model formula generated by the model formula generating part 55 according to genes satisfies the rules of model formulas recorded in the rule DB 47.

### Processing Procedures

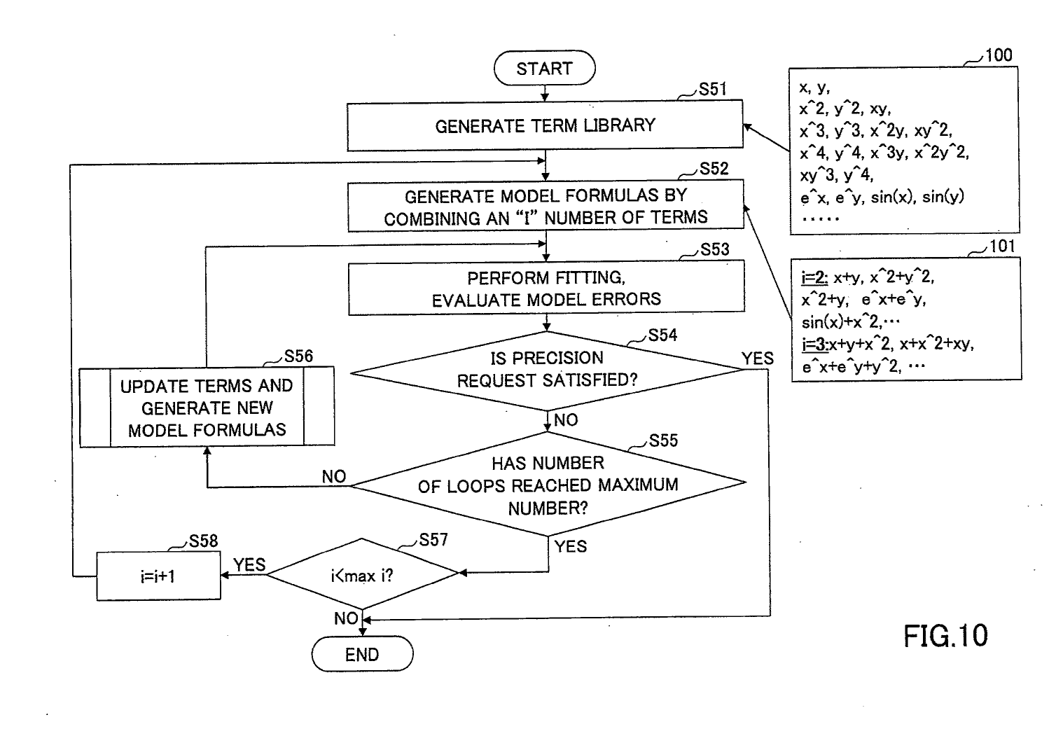

The circuit performance estimation device 40 models relationships between circuit performances and process parameters 2, according to procedures illustrated in FIG. 10. FIG. 10 is a flowchart of the procedures of the modeling process. In the flowchart of FIG. 10, the initial value of “i” is two.

In step S51, the term library generating unit 41 generates a term library 100 including terms of model formulas. Details of the term library 100 are described below. In step S52, the model formula generating unit 42 generates model formulas 101 by combining an “i” number of terms included in the term library 100. Details of the model formula 101 are described below.

In step S53, the model formula selecting unit 43 performs fitting by a method of least squares on the model formulas generated by the model formula generating unit 42, to obtain coefficients {a₀, a₁, . . . , aₙ}.

In step S54, the model formula selecting unit 43 obtains the MSE error between the model formula whose coefficients have been obtained, and simulation data. Then, based on the MSE errors, the model formula selecting unit 43 evaluates the error (precision) of the model formulas.

When there is a model formula whose precision satisfies the precision request among the model formulas generated by the model formula generating unit 42, the model formula selecting unit 43 selects the model formula satisfying the precision request. Then, the process of the flowchart of FIG. 10 ends.

When there are no model formulas whose precision satisfies the precision request among the model formulas generated by the model formula generating unit 42, the process proceeds to step S55, where the model formula selecting unit 43 determines whether the number of loops has reached the maximum number of loops. When the number of loops has not reached the maximum number of loops, the model formula selecting unit 43 instructs the model formula generating unit 42 to update the terms and generate model formulas.

In response to receiving an instruction to update the terms and generate model formulas, in step S56, the model formula generating unit 42 updates the terms and generates new model formulas by combining an “i” number of terms. Then, the process returns to step S53.

Meanwhile, when the number of loops has reached the maximum number of loops, in step S57, the model formula selecting unit 43 determines whether “i” is less than a maximum value “i”. When “i” is less than a maximum value “i”, in step S58, the model formula selecting unit 43 increments the value of “i” by one. Subsequently, the model formula selecting unit 43 instructs the model formula generating unit 42 to generate model formulas. When the model formula generating unit 42 receives an instruction to generate model formulas, the process returns to step S52, and the procedures from step S52 are repeated.

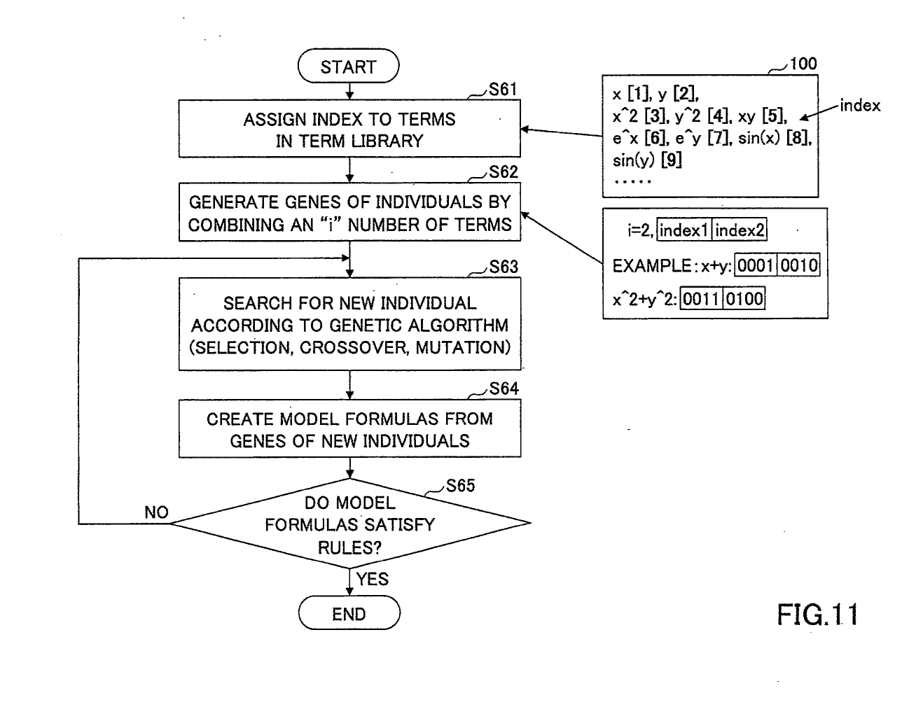

FIG. 11 is a flowchart indicating details of step S56. In step S61, the index assigning part 52 included in the model formula generating unit 42 assigns an index to each term included in the term library 100. For example, indices expressing [1] through [9] by binary digits are assigned to the terms in the term library 100 of FIG. 11.

In step S62, the gene generating part 53 generates genes of individuals by combining an “i” number of terms included in the term library 100. For example, FIG. 11 indicates a gene “00010010” of an individual “x+y” generated by combining “x” of [1] and “y” of [2]. For example, FIG. 11 indicates a gene “00110100” of an individual “x²+y²” generated by combining “x²” of [3] and “y²” of [4].

In step S63, the genetic algorithm processing part 54 searches for new individuals according to conventionally known genetic algorithm.

For example, as indicated in FIG. 11, from parent genes “00010010” and “00110100”, an individual of a gene “00110010” is created by crossover, and an individual of a gene “00110101” is created by mutation.

In step S64, the model formula generating part 55 according to genes generates model formulas from genes of new individuals found by the genetic algorithm processing part 54. For example, in the example of FIG. 11, a model formula “x²+xy” is generated from an individual of the gene “00110101” created in step S63.

In step S65, the rule determining part 56 determines whether the model formulas generated by the model formula generating part 55 according to genes satisfy rules recorded in the rule DB 47. Examples of rules are that the terms exist in the term library 100, the indices of the terms do not overlap, the terms of the model formulas do not overlap, and the model formulas do not overlap.

When the rule determining part 56 determines that the model formulas do not satisfy the rules, the rule determining part 56 instructs the genetic algorithm processing part 54 to search for new individuals. When the genetic algorithm processing part 54 receives the instruction to search for new individuals, the process returns to step S63, and the procedures from step S63 are repeated. When the rule determining part 56 determines that the model formulas satisfy the rules, the process of the flowchart of FIG. 11 ends.

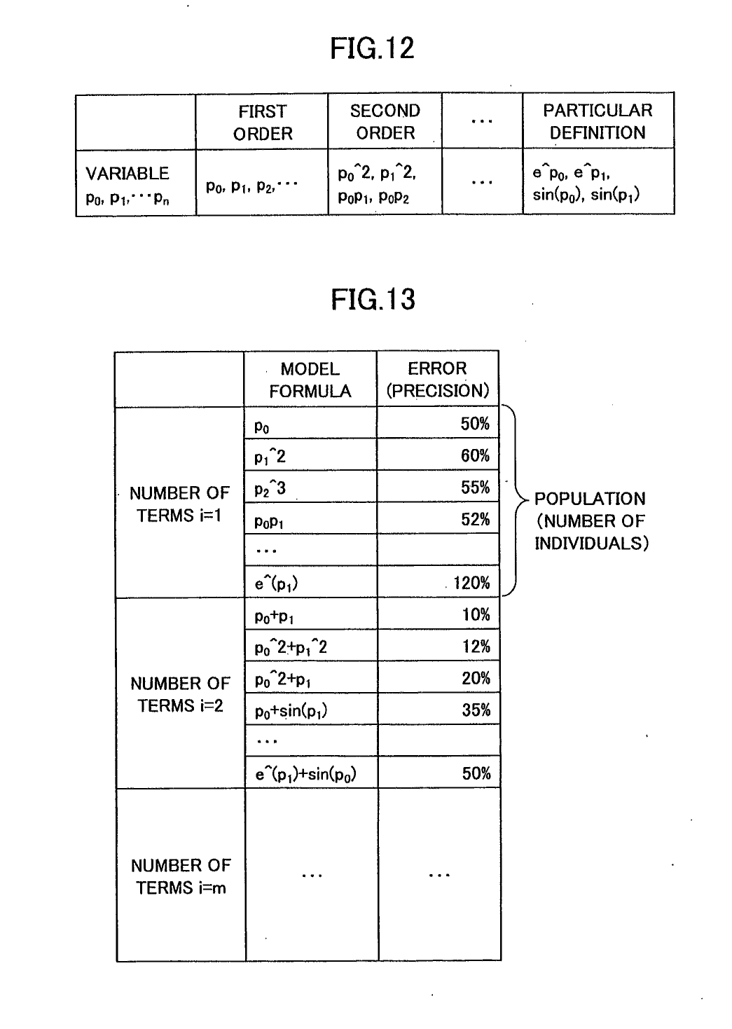

FIG. 12 illustrates a configuration of an example of the term library 100. The term library 100 of FIG. 12 indicates terms of a first order, a second order, . . . , and a particular definition, when the variables of the model formulas are {p₀, p₁, . . . , pₙ}. The term library 100 of FIG. 12 is recorded in the term library DB 45.

FIG. 13 illustrates the association between model formulas and errors (precision) of the model formulas. In FIG. 13, model formulas generated by combining an “i” number of terms (i=1 through m) and the errors (precision) of the model formulas are associated with each other. The number of model formulas when “i” is one corresponds to the number of individuals (population). The model formulas of FIG. 13 and the errors (precision) of the model formulas are recorded in the model formula DB 46.

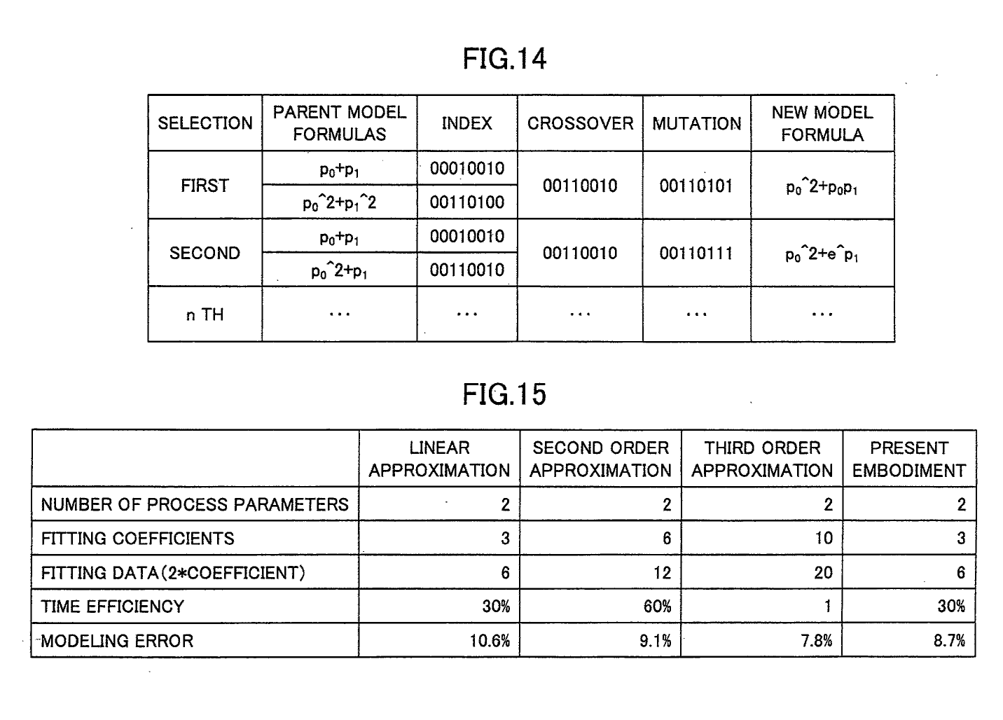

FIG. 14 illustrates an example of genetic algorithm information. The example of genetic algorithm information of FIG. 14 indicates associations of parent model formulas, indices corresponding to parent genes, genes searched according to crossover, genes searched according to mutation, and model formulas generated from genes searched according to mutation. The genetic algorithm information of FIG. 14 is recorded in the genetic algorithm DB 48.

FIG. 15 indicates effects of the present embodiment by comparing the present embodiment with conventional methods. FIG. 15 indicates the number of process parameters, fitting coefficients, fitting data, time efficiency, and modeling errors in model formulas of conventional methods including linear approximation, second order approximation, third order approximation, as well as in a model formula of the present embodiment. As indicated in FIG. 15, the model formula according to the present embodiment has the same number of data items as that of linear approximation, and has better precision (fewer errors) compared to that of second order approximation.

In the present embodiment, a model formula indicates the relationship between circuit performances and process parameters 2. The model formula is generated by searching for optimum terms from the term library 100 created from the process parameters 2. Accordingly, the precision in estimating circuit performances and the processing time are balanced. A genetic algorithm may be used as a method for searching for optimum terms from the term library 100 and generating a model formula.

According to one embodiment of the present invention, the precision in estimating circuit performances and the processing time are balanced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a program that causes a computer for estimating circuit performances to execute a procedure, the procedure comprising:
acquiring terms from a recording unit recording the terms included in model formulas indicating relationships between circuit performances and parameters;
generating new model formulas by combining the terms acquired at the acquiring;
performing simulation on the new model formulas generated at the generating; and
selecting a model formula that satisfies a precision request from among the new model formulas, based on simulation results obtained at the performing of the simulation.

2. The computer-readable, non-transitory medium according to claim 1, wherein
the generating further includes generating the new model formulas by genetic algorithm from the terms acquired from the recording unit.

3. The computer-readable, non-transitory medium according to claim 1, wherein
the generating further includes generating the new model formulas by sequentially increasing a number of combinations of the terms, until the model formula that satisfies the precision request is selected.

4. The computer-readable, non-transitory medium according to claim 1, wherein
the performing the simulation further includes performing fitting on the new model formulas generated at the generating to obtain coefficients of the model formulas, and evaluating precision of the model formulas whose coefficients have been obtained.

5. A circuit performance estimation method for estimating circuit performances, the circuit performance estimation method comprising:
acquiring terms from a recording unit recording the terms included in model formulas indicating relationships between circuit performances and parameters;
generating new model formulas by combining the terms acquired at the acquiring;
performing simulation on the new model formulas generated at the generating; and
selecting a model formula that satisfies a precision request from among the new model formulas, based on simulation results obtained at the performing of the simulation.

6. A circuit performance estimation device for estimating circuit performances, the circuit performance estimation device comprising:
an acquiring unit that acquires terms from a recording unit recording the terms included in model formulas indicating relationships between circuit performances and parameters;
a generating unit that generates new model formulas by combining the terms acquired by the acquiring unit;
a simulation performing unit that performs simulation on the new model formulas generated by the generating unit; and
a selecting unit that selects a model formula that satisfies a precision request from among the new model formulas, based on simulation results obtained by the simulation performing unit.

7. A circuit performance estimation device for estimating circuit performances, the circuit performance estimation device comprising:
a processor configured to execute a procedure, the procedure comprising:
acquiring terms from a recording unit recording the terms included in model formulas indicating relationships between circuit performances and parameters;
generating new model formulas by combining the terms acquired at the acquiring;
performing simulation on the new model formulas generated at the generating; and
selecting a model formula that satisfies a precision request from among the new model formulas, based on simulation results obtained at the performing of the simulation.
